(19) United States
(12) Patent Application Publication
(10) Pub. No.: US 2021/0289524 A1
(43) Pub. Date: Sep. 16, 2021

(54) USER EQUIPMENT AND SIGNAL TRANSMISSION METHOD

(71) Applicant: NTT DOCOMO, INC., Tokyo (JP)

(72) Inventors: Yousuke Sano, Tokyo (JP); Kazuaki Takeda, Tokyo (JP); Satoshi Nagata, Tokyo (JP)

(73) Assignee: NTT DOCOMO, INC., Tokyo (JP)

(21) Appl. No.: 16/323,352

(22) PCT Filed: Jul. 21, 2017
(86) PCT No.: PCT/JP2017/026500

§ 371 Date: Feb. 5, 2019

(30) Foreign Application Priority Data
Aug. 12, 2016 (JP) 2016-158965

(51) Int. Cl. H04W 72/12

(52) U.S. Cl. CPC H04W 72/1268; H04W 72/1289

(57) ABSTRACT

A user equipment in a wireless communication system that supports a first uplink communication scheme in which a user equipment selects a predetermined uplink radio resource autonomously and a second uplink communication scheme in which a base station allocates an uplink radio resource to the user equipment includes: an acquisition unit that acquires instruction information that indicates any one of the first uplink communication scheme and the second uplink communication scheme from the base station; and a transmission unit that transmits an uplink signal using the first uplink communication scheme or the second uplink communication scheme according to the instruction information.

### TECHNICAL FIELD

The present invention relates to a user equipment and a signal transmission method.

### BACKGROUND ART

In LTE (Long Term Evolution), a next-generation (called 5G) wireless communication system has been discussed in order to realize a larger system capacity, a higher data transmission rate, and a lower latency in a wireless segment.

In 5G, various elemental techniques have been discussed to meet requirements that latency in a wireless segment is to be equal to or smaller than 1 ms while realizing throughput of 10 Gbps or higher. Moreover, an elemental technique for enabling a massively large number of MTC (Machine Type Communication) terminals to access a wireless network in order to cope with a service represented by IoT (Internet of Things) has been discussed. In 5G, a technique for enabling a large number of MTC terminals to access a network is referred to as mMTC (Massive machine-type-communications).

### CITATION LIST

### Non-Patent Document

Non-Patent Document 1: 3GPP TR 38.91.3 V0.2.0 (2016 February)

### SUMMARY OF THE INVENTION

### Problem to be Solved by the Invention

In current LTE, in order to prevent collision of UL (Uplink) signals, a non-contention-based access scheme in which a base station controls scheduling of UL according to a PA procedure (random access procedure) is employed. On the other hand, in mMTC discussed in 5G, the use of contention-based access scheme (also referred to as Grant-free access, message-base transmission, and non-orthogonal access scheme) in which a plurality of MTC terminals shares uplink radio resources, and contention of UL signals is allowed to enable efficient transmission of UL signals has been discussed.

However, in the contention-based access scheme, since the base station cannot control UL resources, it is expected that the MTC terminal determines the UL resource autonomously. In this case, particularly, in a high traffic environment, the probability that a plurality of MTC terminals transmit UL signals simultaneously using the same UL resource increases, and the communication capacity may deteriorate. In order to obviate such a problem, it is considered preferable to switch the non-contention-based access scheme and the contention-based access scheme efficiently depending on a traffic environment.

The disclosed technique has been in view of the above-described circumstance, and an object thereof is to provide a technique for enabling a non-contention-based access scheme and a contention-based access scheme to be switched efficiently.

### Means for Solving Problem

A user equipment of the disclosed technique is a user equipment in a wireless communication system that supports a first uplink communication scheme in which a user equipment selects a predetermined uplink radio resource autonomously and a second uplink communication scheme in which a base station allocates an uplink radio resource to the user equipment, the user equipment including: an acquisition unit that acquires instruction information that indicates any one of the first uplink communication scheme and the second uplink communication scheme from the base station; and a transmission unit that transmits an uplink signal using the first uplink communication scheme or the second uplink communication scheme according to the instruction information.

### Effect of the Invention

According to the disclosed technique, a technique for enabling a non-contention-based access scheme and a contention-based access scheme to be switched efficiently is provided.

### BRIEF DESCRIPTION OF DRAWINGS

FIG. 1 is a diagram illustrating a configuration example of a wireless communication system according to an embodiment;

FIG. 2 is a diagram illustrating an example of a non-contention-based access scheme;

FIG. 3 is a diagram illustrating an example of a contention-based access scheme;

FIG. 4 is a diagram illustrating an example in which radio resources are subdivided for respective access schemes;

FIG. 5 is a diagram illustrating an example of the format of a UL signal used in a contention-based access scheme;

FIG. 6 is a diagram illustrating an example of a processing procedure that the wireless communication system according to the embodiment performs;

FIG. 7 is a diagram illustrating an example of a modification of a processing procedure that the wireless communication system according to the embodiment performs;

FIG. 8 is a diagram illustrating an example of the format of a UL signal that is re-transmitted;

FIG. 9 is a diagram for describing a transmission resource capable of transmitting UL signals in time-domain spreading;

FIG. 10 is a diagram illustrating an example of a functional configuration of a user equipment according to the embodiment;

FIG. 11 is a diagram illustrating an example of a functional configuration of a base station according to the embodiment; and

FIG. 12 is a diagram illustrating an example of a hardware configuration of the base station and the user equipment according to the embodiment.

### MODE(S) FOR CARRYING OUT THE INVENTION

Hereinafter, an embodiment of the invention will be described with reference to the drawings. The embodiment to be described below is an example only, and an embodiment to which the invention is applied is not limited to the following embodiment. For example, although a wireless communication system according to the present embodiment is a system of a scheme compatible with LTE, the invention is not limited to LTE but can be applied to other schemes. In the present specification and the claims, “LTE” is used in a broad sense to include 5G communication schemes corresponding to 3GPP release 10, 11, 12, 13, 14, or later as well as communication schemes corresponding to 3GPP release 8 or 9. In the following description, “resource” is used in the meaning of radio resource.

<System Configuration>

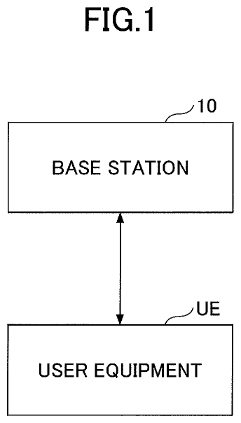

FIG. 1 is a diagram illustrating a configuration example of a wireless communication system according to an embodiment. As illustrated in FIG. 1, the wireless communication system according to the present embodiment includes a base station 10 and a user equipment UE. Although one base station 10 and one user equipment UE are illustrated in FIG. 1, two or more base stations and two or more user equipments UEs may be provided. The user equipment UE may be an MTC terminal and may be an MBB (Mobile Broad Band) terminal such as a smartphone. That is, the user equipment UE of the present embodiment may be any type of terminal.

The user equipment LIE and the base station 10 support a non-contention-based access scheme and a contention-based access scheme in UL, and the user equipment UE switches whether the user equipment UE transmits UL signals using the non-contention-based access scheme or transmits UL signals using the non-contention-based access scheme according to an instruction of the base station 10.

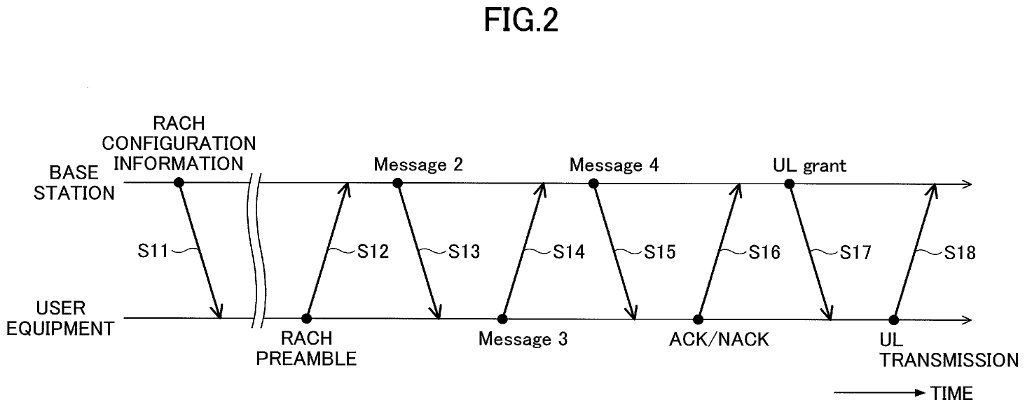

FIG. 2 illustrates an example of the non-contention-based access scheme. The access scheme illustrated in FIG. 2 corresponds to a random access procedure in the current LTE. In the non-contention-based access scheme, the base station 10 notifies RACH configuration information including a range of resources that are to transmit a RACH (Random Access Channel) preamble, parameters of the RACH preamble, and the like to the user equipment UE using notification information (broadcast information) and the like (S11). The user equipment UE transmits the RACH preamble to the base station 10 on the basis of the RACH configuration information when transmitting UL signals (S12). After that, Message 2, Message 3, Message 4, and ACK/NACK to Message 4 are transmitted and received between the base station 10 and the user equipment UE, and the user equipment UE transmits UL signals using resources allocated by UL grant (S13 to S18).

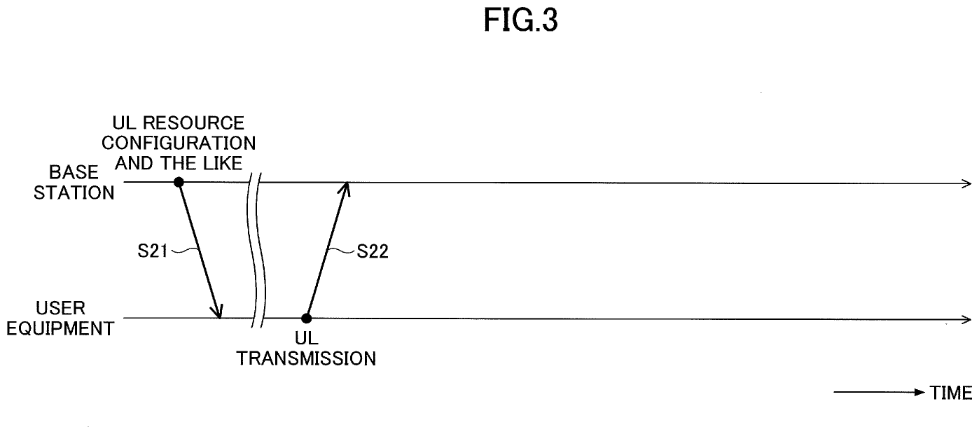

FIG. 3 illustrates an example of the contention-based access scheme. In the contention-based access scheme according to the present embodiment, the base station 10 notifies a range of resources that are to transmit UL signals using the contention-based access scheme, various parameters to be applied to UL signals, and the like to the user equipment UE using notification information (broadcast information), RRC signaling, or the like (S21). The user equipment UE randomly selects a resource to be used for transmitting UL signals among the range of resources notified from the base station 10 and transmits UL signals using the selected resource (S22).

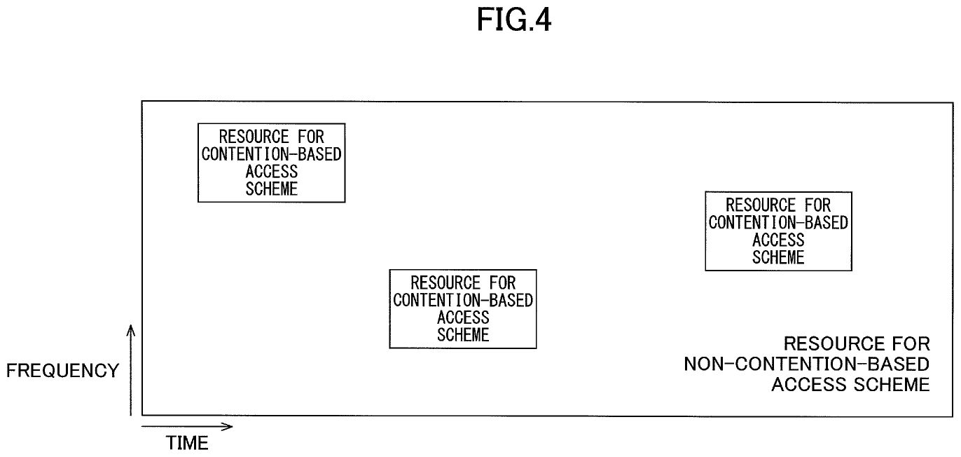

The resources used for the non-contention-based access scheme and the resources used for the contention-based access scheme may be subdivided as illustrated in FIG. 4. However, the present invention is not limited to this, and the resources used for the non-contention-based access scheme and the resources used for the contention-based access scheme may not be subdivided particularly.

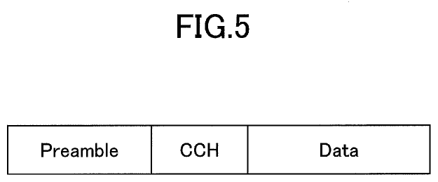

FIG. 5 illustrates an example of the format of a UL signal used in the contention-based access scheme. As illustrated in FIG. 5, the UL signal according to the present embodiment may include “Preamble,” “CCH (Control Channel),” and “Data”. The “Preamble” is an area in which a preamble used for uplink signal detection, beam forming measurement, channel estimation, and the like in the base station 10 is stored. The “CCH” is an area in which uplink control information indicating BSR (Buffer Status Report), UE-ID, UE capability, transmission power information (for NOMA), a modulation scheme, a coding rate, the location of time and frequency resources to which UL data is mapped, and the like is stored. The “Data” is an area in which UL data such as user data is stored. The UL signal illustrated in FIG. 5 is an example only and the present embodiment is not limited to this.

### <Processing Procedure>

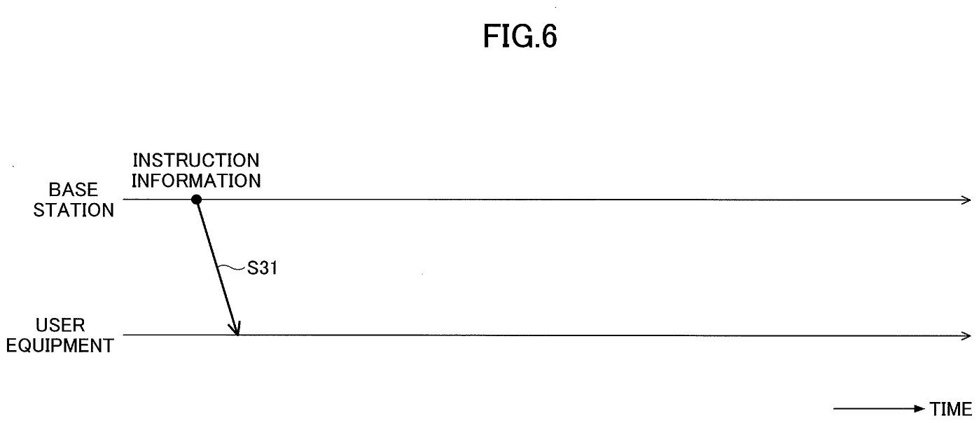

FIG. 6 is a diagram illustrating an example of a processing procedure that the wireless communication system according to the embodiment performs. The base station 10 monitors a traffic state in a cell, instructs the user equipment UE to transmit UL signals using the non-contention-based access scheme when the traffic volume is equal to or larger than a predetermined threshold (the traffic is high), and instructs the user equipment UE to transmit UL signals using the contention-based access scheme when the traffic volume is smaller than the predetermined threshold (the traffic is low) (S31). In the following description, information that instructs the user equipment UE to use the non-contention-based access scheme or the contention-based access scheme to transmit UL signals will be referred to as “instruction information”. The instruction information may be notification information (broadcast information), MIB (Master Information Block), or aperiodic SIB (Aperiodic System Information Block) and may be individual RRC signalings. The instruction information may include the range of resources that can transmit UL signals using the contention-based access scheme, various parameters to be applied to UL signals, and the like.

In order to prevent the instruction information from being transmitted frequently when the traffic volume approaches the predetermined threshold, the base station 10 may provide hysteresis in addition to the predetermined threshold and may inhibit subsequent instruction information from being transmitted until a predetermined timer value expires after previous instruction information is transmitted.

In the present embodiment, in order to realize efficient UL signal separation between a plurality of user equipments UEs, frequency-domain spreading or time-domain spreading based on spread codes may be applied to UL signals of the contention-based access scheme. As a spreading scheme, a code spreading (CDMA: Code Division Multiple Access) scheme may be used, and low-coding spreading (for example, IDMA: Interleave Division Multiple Access) may be used. The present invention is not limited to this, and other spectrum spreading schemes may be used.

A spreading factor when applying frequency-domain spreading or time-domain spreading may be determined in advance by standard specifications or the like, and the base station 10 may insert the spreading factor to the “instruction information” and indicate the spreading factor to the user equipment UE. The user equipment UE may randomly select a spread code to be used when transmitting UL signals according to the spreading factor among a plurality of orthogonal spread code patterns determined in advance for each spreading factor. The spread code may be an arbitrary code, and an OVSF (Orthogonal Variable Spreading Factor) code may be used, for example.

Moreover, when indicating the spreading factor when applying the frequency-domain spreading or the time-domain spreading to the user equipment UE, the base station 10 may indicate different spreading factors depending on the traffic volume. For example, a table that correlates a range of traffic volumes and the spreading factor with each other may be retained in advance in a memory or the like, and the spreading factor corresponding to the traffic volume may be determined by referring to the table and be indicated to the user equipment UE.

The table may correlate the range of the traffic volumes and the spreading factor with each other such that the spreading factor increases as the traffic volume increases. In this way, a high spreading factor is applied for a high traffic, and the probability that the orthogonality between UL signals is maintained can be increased. However, the present invention is not limited to this, and the table may correlate the range of traffic volumes and the spreading factor with each other such that the spreading factor decreases as the traffic volume increases, for example.

In the contention-based access scheme, since resource allocation (transmission of UL grant) from the base station 10 to the user equipment UE is not performed unlike the non-contention-based access scheme, it is not possible to designate MCS (Modulation and Coding scheme) to be applied to UL signals to the user equipment UE. Due to this, the base station 10 may insert the MCS to be applied to the UL signal to the “instruction information” and indicate the MCS to the user equipment UE. Indicating the MCS means indicating a modulation scheme and a coding rate (Code rate) to be applied to UL signals. The base station 10 may explicitly indicate the modulation scheme and the coding rate to the user equipment UE and may implicitly indicate the modulation scheme and the coding rate to the user equipment UE by notifying an index value on the basis of a table in which a modulation scheme and a coding rate, and an index value are correlated with each other.

The base station 10 may change the MCS to be applied to UL signals according to a traffic volume. For example, a table in which a range of traffic volumes and a MCS (a modulation scheme and a coding rate) are correlated with each other may be retained in advance in a memory or the like, and the MCS corresponding to the traffic volume may be determined by referring to the table and may be indicated to the user equipment UE.

The table correlates the range of traffic volumes and the MCS such that the MCS decreases as the traffic volume increases, for example, (at least one of the bit rate of the modulation scheme and the coding rate decreases as the traffic volume increases). In this way, it is possible to increase the possibility that UL signals are received by the base station 10 even when the traffic is high. Moreover, the present invention is not limited to this, and the table may correlate the range of traffic volumes and the MCS with each other such that the MCS increases as the traffic volume increases, for example.

The “instruction information” may be a flag that explicitly indicate the non-contention-based access scheme or the contention-based access scheme. That is, the user equipment UE may switch whether the user equipment UE transmits UL signals using the non-contention-based access scheme or transmits UL signals using the non-contention-based access scheme by recognizing the flag. Moreover, the “instruction information” may implicitly indicate the non-contention-based access scheme or the contention-based access scheme. For example, the user equipment UE may regard that the user equipment UE is instructed to use the contention-based access scheme when the spreading factor or the MCS is included in the “instruction information” and may regard that the user equipment UE is instructed to use the non-contention-based access scheme when the spreading factor or the MCS is not included in the “instruction information”.

(Modification of Transmission of UL Signals)

When frequency-domain spreading or time-domain spreading based on spread code is applied to UL signals of the contention-based access scheme, the user equipment UE may transmit UL signals without performing frequency-domain or time-domain spreading when transmitting UL signals at the first time and may re-transmit UL signals while performing frequency-domain or time-domain spreading according to the spreading factor indicated by the instruction information when re-transmitting UL signals.

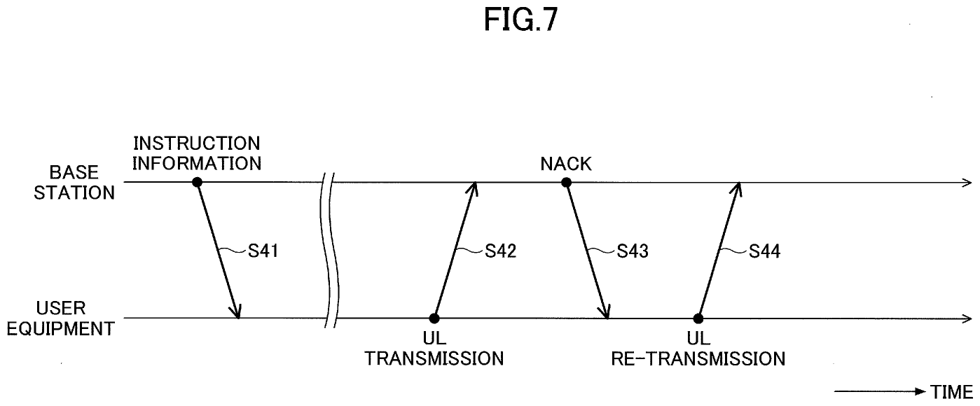

FIG. 7 is a diagram illustrating an example of a modification of a processing procedure that the wireless communication system according to the embodiment performs. Since a processing procedure of step 341 is the same as the processing procedure of step S31 in FIG. 6, the description thereof will be omitted.

In step S42, when transmitting UL signals at the first time, the user equipment UE transmits UL signals without performing frequency-domain or time-domain spreading on signals corresponding to the “Data” of the UL signals. Here, as for the MCS to be applied to the first UL signals, the MCS indicated by the instruction information may be used, and the MCS determined by the user equipment UE itself may be used. In the latter case, the user equipment UE notifies the modulation scheme and the coding rate to be applied to the signals corresponding to “Data” to the base station 10 by inserting the MCS (which may be the index value and may explicitly indicate the modulation scheme and the coding rate) determined by itself to the “CCH” included in the UL signals.

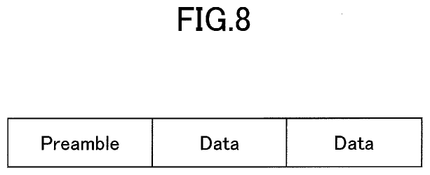

When NACK is transmitted from the base station 10 in step S43, the user equipment UE performs frequency-domain or time-domain spreading according to the spreading factor indicated by the “instruction information” and re-transmits UL signals in step S44. Specifically, when re-transmitting UL signals in step S44, the user equipment UE applies the MCS indicated by the instruction information to the signals corresponding to the “Data,” performs frequency-domain or time-domain spreading according to the spreading factor indicated by the instruction information on the signal corresponding to the “Data,” and re-receives UL signals. FIG. 8 illustrates an example of the format of the re-transmitted UL signal. The example of FIG. 8 illustrates a state in which time-domain spreading with the spreading factor of 2 is performed. Since the MCS indicated by the instruction information is applied to the re-transmitted UL signal, the “CCH” may be omitted in the re-transmitted UL signal as illustrated in FIG. 8. The present invention is not limited to this, and the “CCH” may not be omitted.

According to the modification described above, since frequency-domain or time-domain spreading is not performed on the UL signals transmitted at the first time, it is possible to reduce the possibility that the UL signals interfere with UL signals transmitted by a neighboring cell or another user equipment UE.

(MCS and Spreading Factor)

When the MCS and/or the spreading factor is not included in the “instruction information,” the user equipment UE may determine a modulation scheme and a coding rate and/or a spreading factor to be applied when transmitting UL signals using the contention-based access scheme on the basis of the reception quality (RSRP, RSRQ, RSSI, or SINR) of a reference signal included in DL signals transmitted from the base station 10. In this way, even when there is no explicit instruction from the base station 10, the user equipment UE can apply a modulation scheme, a coding rate, and a spreading factor appropriate for the reception quality of DL.

(Transmission Resources when Applying Frequency-Domain Spreading or Time-Domain Spreading)

The user equipment UE may limit transmission resources according to the spreading factor when applying frequency-domain spreading or time-domain spreading in the contention-based access scheme. For example, the user equipment UE performs frequency-domain spreading or time-domain spreading, starting from a transmission resource indicated by an index corresponding to a multiple of the spreading factor. The spread code used for spreading may be selected randomly according to the spreading factor among a plurality of orthogonal spread code patterns determined in advance for each spreading factor.

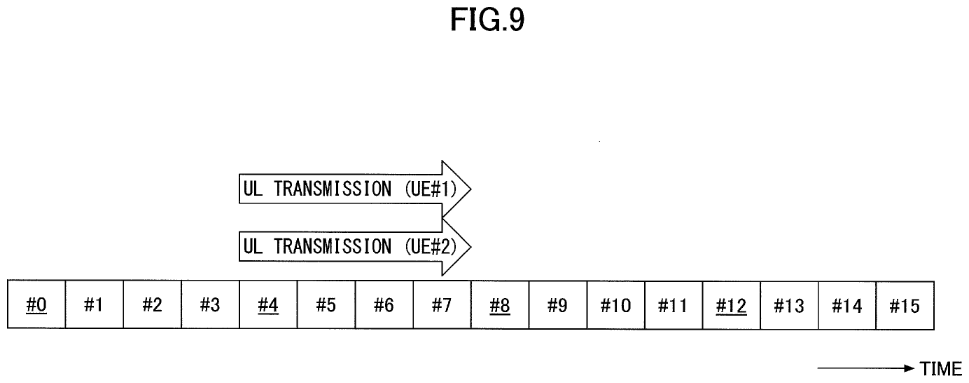

FIG. 9 illustrates an example of transmission resources that can transmit UL signals when applying time-domain spreading. For example, when the spreading factor is 4, the user equipment UE spreads UL signals to four transmission resources (#0 to #3, #4 to #7, #8 to #11, or #12 to #15) in a time direction, starting from a transmission resource (#0, #4, #8, or #12) of which the index is a multiple of 4, for example. When the spreading factor is 8, the user equipment UE spreads UL signals to eight transmission resources (#0 to #7 or #8 to #15) in a time direction, starting from a transmission resource (#0 or #8) of which the index is a multiple of 8, for example.

In the case of time-domain spreading, the transmission resource indicated by the index may be a transmission resource indicated by a subframe number, a transmission resource indicated by a slot number, and a transmission resource indicated by a symbol number. In the case of frequency-domain spreading, the transmission resource indicated by the index may be a transmission resource indicated by a resource block index and a transmission resource indicated by a subcarrier number.

As described above, when the transmission resources are limited by the spreading factor, since the same transmission resources of the UL signals to which the same spreading factor is applied are used for different user equipments UEs like UE #1 and UE #2 in FIG. 9, for example, even if UL signals collide between user equipments UEs, the base station 10 can decode UL signals unless the same spread code is selected by different user equipments UEs.

<Functional Configuration>

(User Equipment)

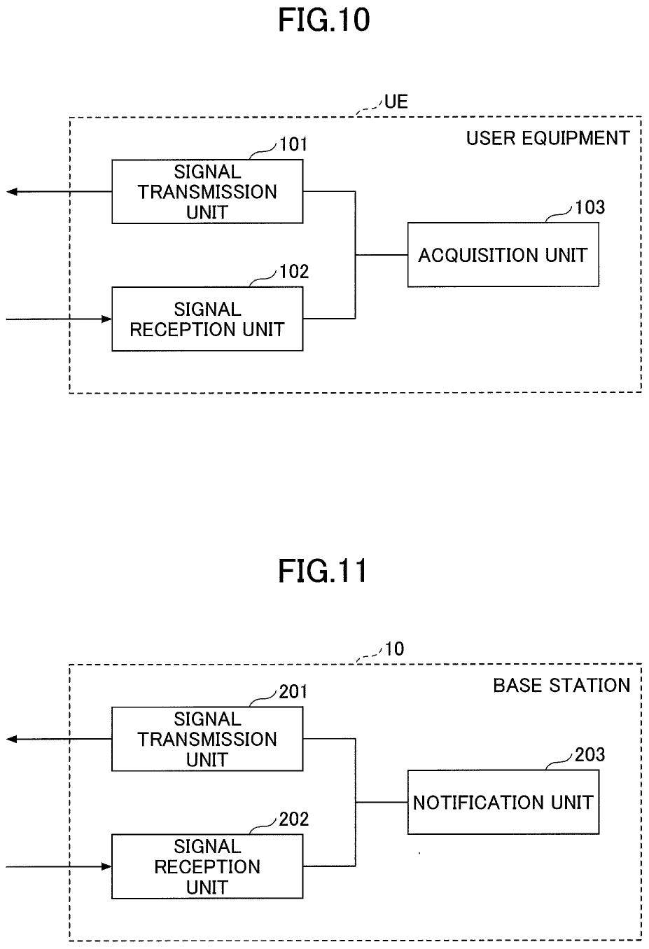

FIG. 10 is a diagram illustrating an example of a functional configuration of a user equipment according to the embodiment. As illustrated in FIG. 10, the user equipment: UE includes a signal transmission unit 101, a signal reception unit 102, and an acquisition unit 103. FIG. 10 illustrates functional units of the user equipment UE particularly related to the embodiment only and also includes at least functions (not illustrated) for performing operations compatible with a wireless communication scheme according to the present embodiment. Moreover, the functional configurations illustrated in FIG. 10 are examples only. The functional classifications and the names of the functional units are not particularly limited as long as the operations according to the present embodiment can be executed.

The signal transmission unit 101 includes a function of generating various signals of the physical layer from higher-layer signals to be transmitted from the user equipment UE and transmitting the signals wirelessly. The signal reception unit 102 includes a function of wirelessly receiving various signals from the base station 10 and acquiring higher-layer signals from the received physical-layer signals.

The signal transmission unit 101 includes a function of transmitting uplink signals using a first uplink communication scheme (contention-based access scheme) or a second uplink communication scheme (non-contention-based access scheme) according to the instruction information.

When the instruction information indicates the first uplink communication scheme (the contention-based access scheme), the signal transmission unit 101 may apply the modulation scheme and the coding rate included in the instruction information, performs frequency-domain spreading or time-domain spreading according to the spreading factor included in the instruction information, and transmit uplink signals.

The signal transmission unit 101 may transmit UL signals without performing frequency-domain spreading or time-domain spreading when transmitting UL signals at the first time and may perform frequency-domain spreading or time-domain spreading according to the spreading factor included in the instruction information and re-transmit UL signals when re-transmitting the UL signals.

The signal transmission unit 101 may perform spreading using resources in a frequency direction starting from a predetermined resource indicated by an index corresponding to a multiple of a spreading factor when performing frequency-domain spreading according to the spreading factor included in the instruction information and may perform spreading using resources in a time direction starting from a predetermined resource indicated by an index corresponding to a multiple of a spreading factor when performing time-domain spreading according to the spreading factor included in the instruction information.

The signal transmission unit 101 may determine a modulation scheme or a coding rate to be applied to a first uplink communication scheme (the contention-based access scheme) on the basis of reception quality of a reference signal included in DL signals transmitted from the base station 10 when a modulation scheme or a coding rate to be applied to the first uplink communication scheme (the contention-based access scheme) is not included in the instruction information.

The acquisition unit 103 includes a function of acquiring instruction information indicating any one of the first uplink communication scheme (the contention-based access scheme) and the second uplink communication scheme (the non-contention-based access scheme) from the base station 10. The instruction information may include a modulation scheme, a coding rate and a spreading factor of frequency-domain spreading or time-domain spreading to be applied to the first uplink communication scheme (the contention-based access scheme).

(Base Station)

FIG. 11 is a diagram illustrating an example of a functional configuration of the base station according to the embodiment. As illustrated in FIG. 10, the base station 10 includes a signal transmission unit 201, a signal reception unit 202, and a notification unit 203. FIG. 11 illustrates functional units of the base station 10 particularly related to the embodiment only and also includes at least functions (not illustrated) for performing operations compatible with a wireless communication scheme according to the present embodiment. Moreover, the functional configurations illustrated in FIG. 11 are examples only. The functional classifications and the names of the functional units are not particularly limited as long as the operations according to the present embodiment can be executed.

The signal transmission unit 201 includes a function of generating various signals of the physical layer from higher-layer signals to be transmitted from the base station and transmitting the signals wirelessly. The signal reception unit 202 includes a function of wirelessly receiving various signals from the user equipment. UE and acquiring higher-layer signals from the received physical layer signals. Moreover, the signal reception unit 202 includes a function of receiving UL signals from the user equipment UE according to the first uplink communication scheme (the contention-based access scheme) or the second uplink communication scheme (the non-contention-based access scheme).

The notification unit 203 includes a function of notifying the instruction information indicating any one of the first uplink communication scheme (the contention-based access scheme) and the second uplink communication scheme (the non-contention-based access scheme) to the user equipment UE.

<Hardware Configuration>

The block diagrams (FIGS. 10 and 11) used in the description of the embodiment illustrate functional blocks. These functional blocks (configuration units) are realized by an arbitrary combination of hardware and/or software. Moreover, means for realizing the respective functional blocks is not particularly limited. That is, the respective functional blocks may be realized by one apparatus which is physically and/or logically coupled and may be realized by a plurality of apparatuses which are physically and/or logically separated and which are directly and/or indirectly (for example, by cables and/or wirelessly) connected.

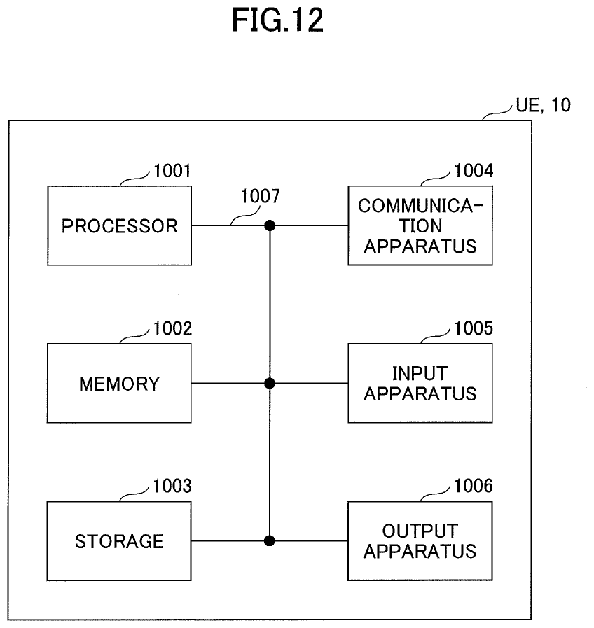

For example, the base station 10, the user equipment UE, and the like according to an embodiment of the present invention may function as a computer that performs processing of the signal transmission method of the present invention. FIG. 12 is a diagram illustrating an example of a hardware configuration of a base station and a user equipment according to an embodiment of the present invention. The base station 10 and the user equipment UE may be physically configured as a computer apparatus which includes a processor 1001, a memory 1002, a storage 1003, a communication apparatus 1004, an input apparatus 1005, an output apparatus 1006, a bus 1007, and the like.

In the following description, the wording “apparatus” may be replaced with circuit, device, unit, or the like. The hardware configuration of the base station 10 and the user equipment UE may include one or a plurality of apparatuses illustrated in the drawings and may not include some apparatuses.

The respective functions of the base station 10 and the user equipment UE are realized when predetermined software (program) is read onto hardware such as the processor 1001, the memory 1002, and the like, the processor 1001 performs an operation, and the communication by the communication apparatus 1004 and the data read and/or write in the memory 1002 and the storage 1003 are controlled.

The processor 1001 operates an operating system to control the entire computer, for example. The processor 1001 may be configured as a central processing unit (CPU) that includes an interface to a peripheral apparatus, a control apparatus, an operation apparatus, a register, and the like. For example, the signal transmission unit 101, the signal reception unit 102, and the acquisition unit 103 of the user equipment UE and the signal transmission unit 201, the signal reception unit 202, the notification unit 203 of the base station 10 may be realized by the processor 1001.

The processor 1001 reads a program (program codes), a software module, or data from the storage 1003 and/or the communication apparatus 1004 into the memory 1002 and executes various processes according to the program and the like. A program for causing a computer to execute at least a portion of the operations described in the embodiment is used as the program. For example, the signal transmission unit: 101, the signal reception unit 102, and the acquisition unit 103 of the user equipment UE and the signal transmission unit 201, the signal reception unit 202, the notification unit 203 of the base station 10 may be realized by a control program which is stored in the memory 1002 and operated by the processor 1001. Moreover, the other functional blocks may be realized by the processor. Although it has been described that the above-described processes are executed by one processor 1001, the processes may be executed by two or more processors 1001 simultaneously or sequentially. One or more chips may be mounted in the processor 1001. The program may be transmitted from a network via a telecommunication circuit.

The memory 1002 is a computer-readable recording medium and may be configured by at least one of a ROM (Read Only Memory), an EPROM (Erasable Programmable ROM), an EEPROM (Electrically Erasable Programmable ROM), a RAM (Random Access Memory), and the like, for example. The memory 1002 may be referred to as a register, a cache, a main memory (main storage device), and the like. The memory 1002 can store a program (program codes), a software module, and the like that can be executed to perform a signal transmission method according to an embodiment of the present invention.

The storage 1003 is a computer-readable recording medium and may be configured by at least one of an optical disc such as a CD-ROM (Compact Disc ROM), a hard disk drive, a flexible disk, an optomagnetic disc (for example, a compact disc, a digital versatile disc, or a Blu-ray (registered trademark) disc), a smartcard, a flash memory (for example, a card, stick, or a key drive), a floppy (registered trademark) disk, a magnetic strip, and the like, for example. The storage 1003 may be referred to as an auxiliary storage apparatus. The above-descried storage medium may be an appropriate medium other than a database and a server that include the memory 1002 and/or the storage 1003.

The communication apparatus 1004 is hardware (transmission and reception device) for performing communication between computers via cables and/or a wireless network and is also referred to as a network device, a network controller, a network card, a communication module, and the like, for example. For example, the signal transmission unit 101 and the signal reception unit 102 of the user equipment UE and the signal transmission unit 201 and the signal reception unit 202 of the base station 10 may be realized by the communication apparatus 1004.

The input apparatus 1005 is an input device (for example, a keyboard, a mouse, a microphone, a switch, a button, a sensor, and the like) that receives the input from the outside. The output apparatus 1006 is an output device (for example, a display, a speaker, an LED lamp, and the like) that outputs information to the outside. The input apparatus 1005 and the output apparatus 1006 may have an integrated configuration (for example, a touch panel).

The respective apparatuses such as the processor 1001 and the memory 1002 are connected by the bus 1007 for communicating information. The bus 1007 may be configured by a single bus and may be configured by different buses for respective apparatuses.

The base station 10 and the user equipment UE may be configured to include hardware such as a microprocessor, a digital signal processor (DSP), an ASIC (Application Specific Integrated Circuit), a PLD (Programmable Logic Device), an FPGA (Field Programmable Gate Array), and the like, and part or all of the respective functional blocks may be realized by the hardware. For example, the processor 1001 may be implemented by at least one of these items of hardware.

<Summary>

According to the embodiment, there is provided a user equipment in a wireless communication system that supports a first uplink communication scheme in which a user equipment selects a predetermined uplink radio resource autonomously and a second uplink communication scheme in which a base station allocates a uplink radio resource to the user equipment, the user equipment including: an acquisition unit that acquires instruction information that indicates any one of the first uplink communication scheme and the second uplink communication scheme from the base station; and a transmission unit that transmits a uplink signal using the first uplink communication scheme or the second uplink communication scheme according to the instruction information. According to this user equipment UE, a technique for enabling a non-contention-based access scheme and a contention-based access scheme to be switched efficiently is provided.

The instruction information may include a modulation scheme, a coding rate, and a spreading factor of frequency-domain spreading or time-domain spreading to be applied to the first uplink communication scheme, and the transmission unit may apply the modulation scheme and the coding rate included in the instruction information, perform frequency-domain spreading or time-domain spreading according to the spreading factor included in the instruction information, and transmit the uplink signal when the instruction information indicates the first uplink communication scheme. Due to this, when the contention-based access scheme is indicated, the user equipment UE can apply the modulation scheme, the coding rate, and the spreading factor appropriate for the contention-based access scheme to the UL signal.

The transmission unit may transmit the uplink signal without performing frequency-domain spreading or time-domain spreading when transmitting the uplink signal at the first time and perform frequency-domain spreading or time-domain spreading according to the spreading factor included in the instruction information and re-transmit the uplink signal when re-transmitting the uplink signal. Due to this, since frequency-domain spreading or time-domain spreading is not performed on the UL signal that is transmitted at the first time, it is possible to reduce the possibility that the UL signal interferes with UL signals transmitted by a neighboring cell or other user equipments UEs.

The transmission unit may perform spreading using resources in a frequency direction starting from a predetermined resource indicated by an index corresponding to a multiple of the spreading factor when frequency-domain spreading is performed according to the spreading factor included in the instruction information and perform spreading using resources in a time direction starting from a predetermined resource indicated by an index corresponding to a multiple of the spreading factor when time-domain spreading is performed according to the spreading factor included in the instruction information. Due to this, since the same transmission resources of the UL signals to which the same spreading factor is applied are used for different user equipments UEs, even if UL signals collide between user equipments UEs, the base station 10 can decode the UL signals.

The transmission unit may determine a modulation scheme or a coding rate to be applied to the first uplink communication scheme on the basis of reception quality of a reference signal included in a downlink signal transmitted from the base station when the modulation scheme or the coding rate to be applied to the first uplink communication scheme is not included in the instruction information. Due to this, the user equipment UE can apply a modulation scheme, a coding rate, and a spreading factor appropriate for the reception quality of DL.

According to the embodiment, there is provided a signal transmission method executed by a user equipment in a wireless communication system that supports a first uplink communication scheme in which a user equipment selects a predetermined uplink radio resource autonomously and a second uplink communication scheme in which a base station allocates a uplink radio resource to the user equipment, the signal transmission method including: acquiring instruction information that indicates any one of the first uplink communication scheme and the second uplink communication scheme from the base station; and transmitting a uplink signal using the first uplink communication scheme or the second uplink communication scheme according to the instruction information. According to this signal transmission method, a technique for enabling a non-contention-based access scheme and a contention-based access scheme to be switched efficiently is provided.

<Supplementary Explanation of Embodiment>

Notification of the instruction information is not limited the aspect and the embodiment described in the present specification but may be performed by other methods. For example, notification of instruction information may be performed via physical layer signaling (for example, DCI (Downlink Control Information) or UCI (Uplink Control Information)), upper-layer signaling (for example, RRC (Radio Resource Control) signaling, MAC (Medium Access Control) signaling, notification information (MIB (Master Information Block)), or SIB (System Information Block)), other signals, or by a combination thereof. Moreover, the RRC signaling may be referred to as a RRC message, and may be an RRC Connection Setup message, a RRC Connection Reconfiguration message, or the like, for example.

The respective aspects and embodiments described in the present embodiment may be applied to LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), a system which uses other appropriate systems, and/or a next-generation system which is extended on the basis of these systems.

The orders in the processing procedures, the sequences, the flowcharts, and the like described in the respective aspects and embodiments described in the present specification may be switched unless contradiction occurs.

For example, in the method described in the present specification, although various steps are illustrated in an exemplary order, the steps are not limited to the illustrated specific order.

The term “system” and “network” used in the present specification is used interchangeably.

The user equipment UE may also be referred to by those skilled in the art as a subscriber station, a mobile station, a subscriber unit, a mobile unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terms.

The base station 10 may also be referred to by those skilled in the art as an NB (NodeB), a base station, an eNB (enhanced NodeB), a base station, or some other suitable terms.

The reference signal may be abbreviated as RS (Reference Signal) and may be referred to as a pilot depending on the applied standards.

The expression “on the basis of” used in the present: specification does not mean “on the basis of only” unless otherwise stated particularly. In other words, the expression “on the basis of” means both “on the basis of only” and “on the basis of at least”.

Any reference to elements which uses namings such as “first” and “second” used in the present specification does not generally limit the quantities or the order of these elements. These namings may be used in the present specification as a method convenient for distinguish two or more elements. Therefore, references to the first and second elements do not mean that only two elements can be employed therein or that the first element precedes the second element in any form.

To the extent that the expressions “including” and “comprising” and variants thereof are used either in the present specification or the claims, these expressions are intended to be inclusive in a manner similar to the expression “having.” Furthermore, the expression “or” used either in the present specification or the claims is not intended to mean “Exclusive-OR”.

In the entire present disclosure, when articles such as a, an, and the are added to an element in the translated English text, for example, such an element to which these articles are added may be provided plurally unless it is clear from the context that the element is provided singly.

The respective aspects and embodiments described in the present specification may be used solely, may be used in combination, and may be switched and used according to execution. Moreover, the notification (notification of “X,” for example) of predetermined information is not limited to being performed explicitly but may be performed implicitly (for example, without performing the notification of the predetermined information).

While the present invention has been described above in detail using the embodiment, it is obvious to those skilled in the art that the present invention is not limited only to the embodiment described in this specification. The present invention can also be embodied in other modified and altered forms without departing from the gist and scope of the present invention as defined in the appended claims. It is therefore to be understood that the disclosure of this specification is intended for the purpose of description and exemplification but is not intended to limit the scope of the invention.

It should be noted that the terms described in the present specification and/or terms necessary for understanding the present specification may be replaced by terms that have the same or similar meaning. For example, a channel and/or a symbol may be a signal. Further, a signal may be a message.

As used herein, the term “determining” may encompasses a wide variety of actions. For example, “determining” may be regarded as calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing and the like. That is, “determining” may be regarded as a certain type of action related to determining.

Information, a signal, etc., described in the present specification may be represented by using any one of the various different techniques. For example, data, an instruction, a command, information, a signal, a bit, a symbol, a chip or the like described throughout in the present specification may be represented by voltage, current, electromagnetic waves, magnetic fields or a magnetic particle, optical fields or a photon, or any combination thereof.

The present application is based on and claims priority to Japanese patent application No. 2016-158965 filed on Aug. 12, 2016, the entire contents of which are hereby incorporated by reference.

### EXPLANATIONS OF LETTERS OR NUMERALS

UE: User equipment
10: Base station
101: Signal transmission unit
102: Signal reception unit
103: Acquisition unit
201: Signal transmission unit
202: Signal reception unit
203: Notification unit
1001: Processor
1002: Memory
1003: Storage
1004: Communication apparatus
1005: Input apparatus
1006: Output apparatus

1. A user equipment in a wireless communication system that supports a first uplink communication scheme in which a user equipment selects a predetermined uplink radio resource autonomously and a second uplink communication scheme in which a base station allocates an uplink radio resource to the user equipment, the user equipment comprising:
an acquisition unit that acquires instruction information that indicates any one of the first uplink communication scheme and the second uplink communication scheme from the base station; and
a transmission unit that transmits an uplink signal using the first uplink communication scheme or the second uplink communication scheme according to the instruction information.

2. The user equipment according to claim 1,
wherein the instruction information includes a modulation scheme, a coding rate, and a spreading factor of frequency-domain spreading or time-domain spreading to be applied to the first uplink communication scheme, and
the transmission unit applies the modulation scheme and the coding rate included in the instruction information, performs frequency-domain spreading or time-domain spreading according to the spreading factor included in the instruction information, and transmits the uplink signal when the instruction information indicates the first uplink communication scheme.

3. The user equipment according to claim 2,
wherein the transmission unit transmits the uplink signal without performing frequency-domain spreading or time-domain spreading when transmitting the uplink signal at the first time and performs frequency-domain spreading or time-domain spreading according to the spreading factor included in the instruction information and re-transmits the uplink signal when re-transmitting the uplink signal.

4. The user equipment according to claim 2,
wherein the transmission unit performs spreading using resources in a frequency direction starting from a predetermined resource indicated by an index corresponding to a multiple of the spreading factor when frequency-domain spreading is performed according to the spreading factor included in the instruction information and performs spreading using resources in a time direction starting from a predetermined resource indicated by an index corresponding to a multiple of the spreading factor when time-domain spreading is performed according to the spreading factor included in the instruction information.

5. The user equipment according to claim 2,
wherein the transmission unit determines a modulation scheme or a coding rate to be applied to the first uplink communication scheme on the basis of reception quality of a reference signal included in a downlink signal transmitted from the base station when the modulation scheme or the coding rate to be applied to the first uplink communication scheme is not included in the instruction information.

6. A signal transmission method executed by a user equipment in a wireless communication system that supports a first uplink communication scheme in which a user equipment selects a predetermined uplink radio resource autonomously and a second uplink communication scheme in which a base station allocates an uplink radio resource to the user equipment, the signal transmission method comprising:
acquiring instruction information that indicates any one of the first uplink communication scheme and the second uplink communication scheme from the base station; and
transmitting an uplink signal using the first uplink communication scheme or the second uplink communication scheme according to the instruction information.

7. The user equipment according to claim 3, wherein the transmission unit performs spreading using resources in a frequency direction starting from a predetermined resource indicated by an index corresponding to a multiple of the spreading factor when frequency-domain spreading is performed according to the spreading factor included in the instruction information and performs spreading using resources in a time direction starting from a predetermined resource indicated by an index corresponding to a multiple of the spreading factor when time-domain spreading is performed according to the spreading factor included in the instruction information.

8. The user equipment according to claim 3, wherein the transmission unit determines a modulation scheme or a coding rate to be applied to the first uplink communication scheme on the basis of reception quality of a reference signal included in a downlink signal transmitted from the base station when the modulation scheme or the coding rate to be applied to the first uplink communication scheme is not included in the instruction information.

9. The user equipment according to claim 4, wherein the transmission unit determines a modulation scheme or a coding rate to be applied to the first uplink communication scheme on the basis of reception quality of a reference signal included in a downlink signal transmitted from the base station when the modulation scheme or the coding rate to be applied to the first uplink communication scheme is not included in the instruction information.
